(19) United States
(12) Patent Application Publication
(10) Pub. No.: US 2003/0031150 A1
(43) Pub. Date: Feb. 13, 2003

(54) Dual network modem

(76) Inventor: Satoru Yukie, San Diego, CA (US)

Correspondence Address: FROMMER LAWRENCE & HAUG, 745 FIFTH AVENUE- 10TH FL., NEW YORK, NY, 10151, US

(21) Appl. No.: 09/927,119

(22) Filed: Aug. 10, 2001

(51) Int. Cl. H04Q 7/24

(52) U.S. Cl. 370/338; 370/349; 370/352; 370/353

(57) ABSTRACT

Methods and apparatus for implementing a wireless modem that operates in two or more wireless networks, such as a packet switched network and a circuit switched network. In one implementation, a modem includes: at least one antenna; a plurality of air interface components, where each air interface component is connected to an antenna and each air interface component corresponds to a respective wireless network, where at least one wireless network is a packet switched network; a modem control component, where the modem control is connected to each of the air interface components; and a modem interface, where the modem interface is connected to the modem control component.

### BACKGROUND

The present invention relates to wireless modems and wireless data networks.

Data as well as voice can be transmitted over existing wireless data networks. Typically, these networks are either circuit switched networks or more recent packet switched networks. In a circuit switched network a temporary dedicated connection is created for communication between two nodes. This connection is maintained throughout the session. Circuit switched networks are typically designed for voice communication. Examples of wireless circuit switched networks include networks using CDMA, such as IS-95 (cdmaOne), IS-95B, or cdma2000, and GSM networks using TDMA. A cellular telephone (“cell phone”) in a typical circuit switched network has a unique telephone number.

In a packet switched network, information is broken into small packets (“packetized”) and packets are individually sent to their destination. The path that individual packets take through the network may vary between packets. The packets are reassembled at the destination. Wireless packet switched networks are typically designed for data transmission. Wireless packet switched networks also typically have faster data transmission rates than wireless circuit switched networks. Examples of wireless packet switched networks include networks using iBurst™ (by ArrayComm, Inc.), flash-OFDM™ (by Flarion Technologies, Inc.), and Ricochet™ (by Metricom, Inc.). A terminal in a typical packet switched network has a unique address, such as a dynamically assigned IP address.

Some conventional cell phones are dual-mode and capable of roaming. A typical dual-mode cell phone can send and receive voice through either of two compatible circuit switched networks. The cell phone selects which of the two networks to use, depending on factors such as availability and quality of connection. Accordingly, a user can “roam” through coverage areas for each of the two networks and still obtain or maintain a connection.

### SUMMARY

The present invention provides methods and apparatus for implementing a wireless modem that operates in two or more wireless networks, such as a packet switched network and a circuit switched network. In one implementation, a modem includes: at least one antenna; a plurality of air interface components, where each air interface component is connected to an antenna and each air interface component corresponds to a respective wireless network, where at least one wireless network is a packet switched network; a modem control component, where the modem control is connected to each of the air interface components; and a modem interface, where the modem interface is connected to the modem control component.

In another implementation, a method for sending and receiving data includes: monitoring availability of a first wireless network and a second wireless network, where the first wireless network is a packet switched network; if the first wireless network is available, sending and receiving data through a first air interface using the first wireless network; and if the first wireless network is not available, sending and receiving data through a second air interface using the second wireless network.

### BRIEF DESCRIPTION OF THE DRAWINGS

FIG. 1 shows coverage areas for two overlapping networks.

FIG. 2 shows a network system illustrating two data paths between a terminal and a server according to the present invention.

FIG. 3 is a block diagram of a wireless modem according to the present invention.

FIG. 4 is a block diagram of a wireless modem according to the present invention.

FIG. 5 is a flow chart of opening a connection between a wireless modem and a server through a wireless network according to the present invention.

FIG. 6 is a flow chart of maintaining a connection between a wireless modem and a server through one or more wireless networks according to the present invention.

### DETAILED DESCRIPTION

The present invention provides methods and apparatus for implementing a wireless modem that operates in two or more wireless networks, such as a packet switched network and a circuit switched network. A terminal device, such as a telephone handset, connected to this wireless modem can transmit and receive data through multiple networks. The terminal can also roam between multiple networks while maintaining the data connection through the modem.

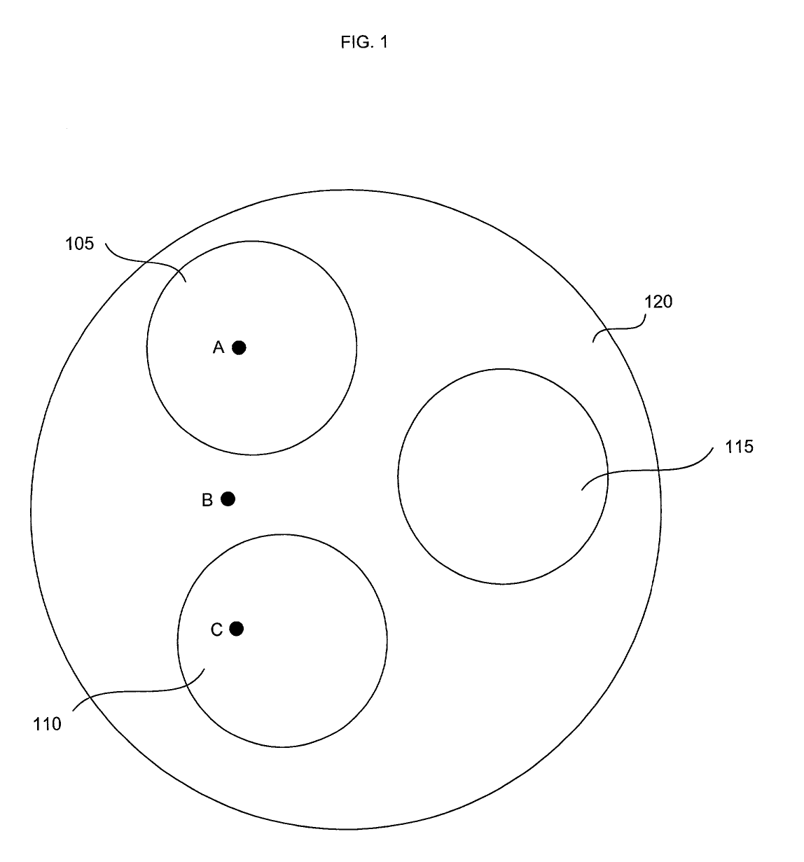

FIG. 1 shows coverage areas for two overlapping networks. Each network is a wireless data network. For example, the first network can be a packet switched network carrying data as IP packets, and the second network can be a circuit switched network such as a cdmaOne network. The first network has coverage areas 105, 110, 115. The second network has coverage area 120. Coverage areas 105, 110, 115 overlap coverage area 120. FIG. 1 also shows three physical locations indicated by points A, B, C. Points A and C are within coverage areas 105 and 110, respectively, for the first network and coverage area 120 of the second network. Point B is within coverage area 120 of the second network but not within a coverage area of the first network. Accordingly, a user at point A or C can transmit and receive data using either the first network or the second network. A user at point B can transmit and receive data using the second network but not the first network. Similarly, a user moving from point A to point C can transmit and receive data using either a combination of the first network and the second network or using only the second network.

When the first network has a higher data transmission rate than the second network, it may be desirable to use the first network rather than the second network when possible. However, it may also be desirable to continue to transmit and receive data from various locations which are outside the coverage areas for the first network. Accordingly, it is advantageous to provide a user with a terminal that can roam (i.e., physically move through different coverage areas) across multiple wireless data networks. The present invention provides a wireless modem that can transmit and receive data across a packet switched network and across a circuit switched network. In addition, the modem can transmit and receive data while moving among compatible networks by switching connections among the networks. The wireless modem switches connections seamlessly from the user's point of view.

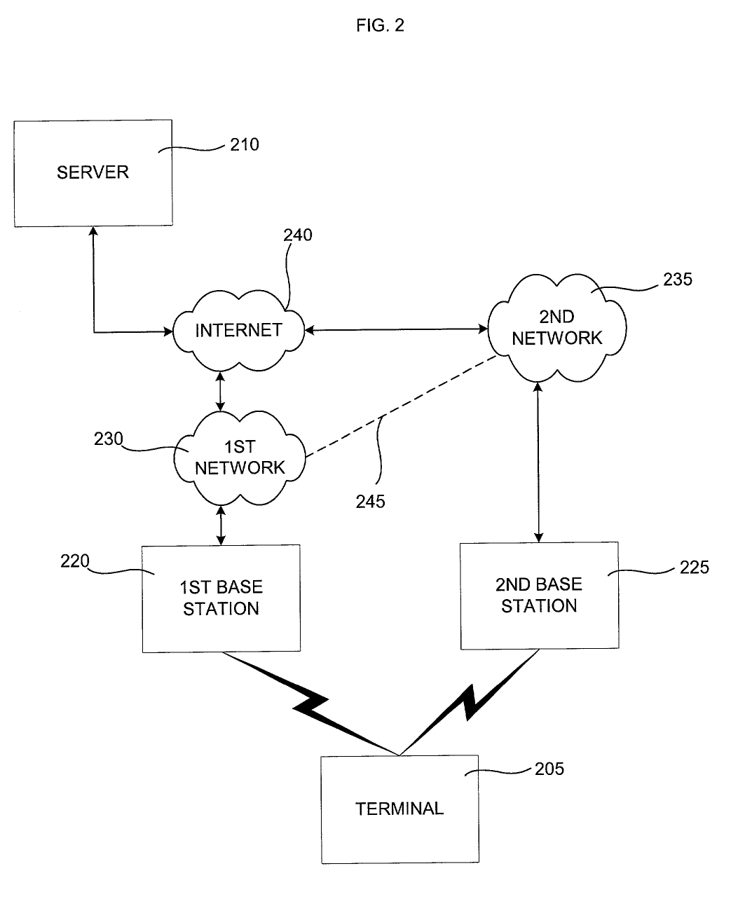

FIG. 2 shows a network system illustrating two data paths between a terminal 205 and a server 210. Terminal 205 includes a wireless modem according to the present invention. Terminal 205 can be implemented as various mobile or portable devices, such as a telephone, a PDA (personal digital assistant), or a notebook computer. In an alternative implementation, terminal 205 is fixed but the wireless modem is portable.

Terminal 205 can transmit and receive data to and from first base station 220 and also to and from second base station 225. First base station 220 is part of a first wireless network 230. Second base station 225 is part of a second wireless network 235. Base stations 220, 225 are the entry points for wireless communication with networks 230, 235, respectively. In one implementation, first network 230 is a packet switched network and second network 235 is a circuit switched network. First network 230 and second network 235 are connected to server 210 through the Internet 240. First network 230 and second network 235 can communicate with one another through the Internet 240 or through a direct connection indicated by dashed line 245.

Terminal 205 can send data to server 210 by establishing a connection to first base station 220. First base station 220 provides data from terminal 205 to server 210 through first network 230 and the Internet 240. Similarly, server 210 can transmit data to terminal 205 through the Internet 240, first network 230, and the connection between first base station 220 and terminal 205. When first network 230 is a packet switched network, data to and from terminal 205 is sent through first network 230 as packets, possibly using various paths through first network 230.

Terminal 205 can also send data to server 210 by establishing a connection to second base station 225. Second base station 225 provides data from terminal 205 through second network 235 and the Internet 240. Similarly, server 210 can transmit data to terminal 205 through the Internet 240, second network 235, and the connection between second base station 225 and terminal 205. When second network 235 is a circuit switched network, data to and from terminal 205 is sent through second network 235 using a temporary dedicated connection.

In one implementation, first network 230 is a primary or default network. Second network 235 is a secondary or alternate network. Terminal 205 has a subscription with the primary network and can also use the secondary network, such as for improved access under poor conditions for the primary network or when roaming. As described below, terminal 205 selects which network to use according to selection criteria. In one implementation, terminal 205 attempts to establish a connection to the primary network (first network 230) and if that connection fails, attempts to establish a connection to the secondary network (second network 235). In addition, terminal 205 selects which of the available networks provides the better service (e.g., higher data rate or lower cost), preferentially selecting the primary network.

The primary network stores subscriber information and provides the subscriber information to secondary or alternate networks upon request. When terminal 205 establishes a connection through second network 235, second network 235 requests subscriber information from first network 230. Second network 235 can request and receive subscriber information from first network 230 through the Internet 240 or through a direct connection 245 to first network 230. Alternatively, both first network 230 and second network 235 store subscriber information. In alternative implementations, more than two networks are available, one primary network and multiple secondary networks.

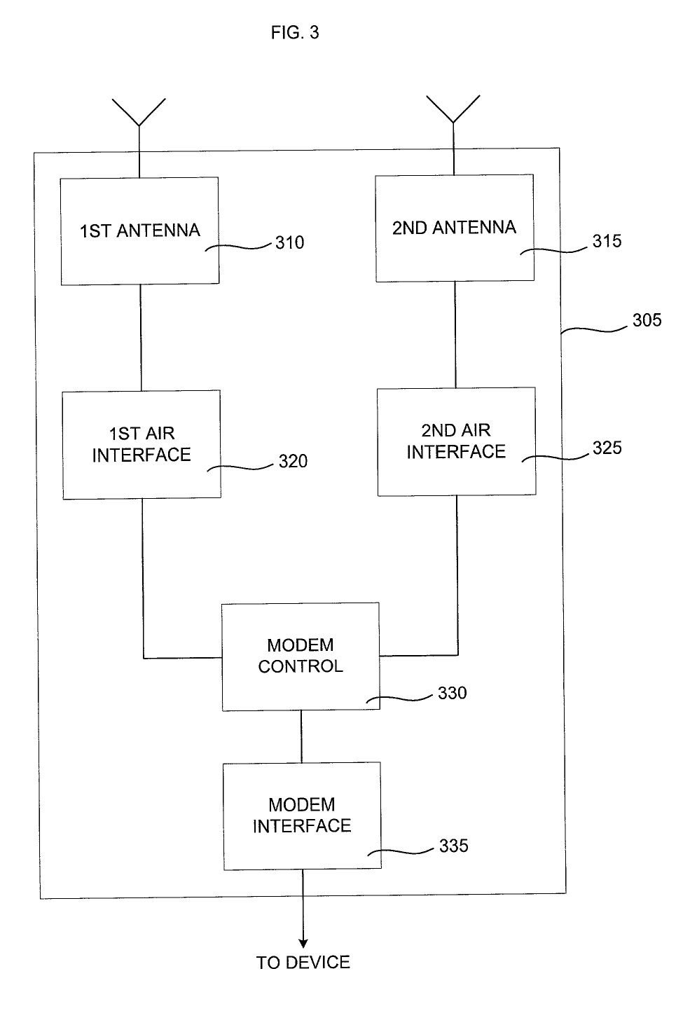

FIG. 3 is a block diagram of a wireless modem 305. Wireless modem 305 includes two antennas: a first antenna 310 and a second antenna 315. Each antenna transmits and receives radio signals within a defined frequency range. For example, in one implementation, first antenna 310 transmits and receives in the 1.8-2 GHz range, and second antenna 315 transmits and receives in the 800-900 MHz range.

Wireless modem 305 includes two air interface components. First antenna 310 is connected to a first air interface 320. Second antenna 315 is connected to a second air interface 325. Each air interface 320, 325 provides encoding and processing for communication with a wireless network. Air interfaces 320, 325 define compatible networks for wireless modem 305. The compatible networks for wireless modem 305 are the networks with which wireless modem 305 can communicate.

In one implementation, first air interface 320 provides for communication with a wireless packet switched data network, such as an iBurs™ network. For transmission, first air interface 320 breaks data to be sent into packets. First air interface 320 encodes the packets, including information to facilitate packet delivery, such as destination information, and provides the encoded data to first antenna 310 for transmission through packet switched first network 230. For reception, first air interface 320 decodes received data into packets and reassembles the packets to provide complete data to modem control 330 and on to the connected device. In an alternative implementation, data is broken into packets and packets are reassembled within first network 230, such as at first base station 220, rather than within wireless modem 305. Second air interface 325 provides for communication with a wireless circuit switched data network, such as a cdmaOne network. Second air interface 325 encodes and decodes data to be sent or received across a circuit connection in second network 235.

Each air interface 320, 325 is connected to a modem control component 330. Modem control 330 controls which antenna and air interface combination to use for transmitting and receiving data. As described below, modem control 330 monitors the availability of connections to wireless networks corresponding to each of air interfaces 320, 325. Modem control 330 selects which wireless network to use based on selection criteria, such as a primary and secondary network relationship, data rate, cost, or energy consumption. The selection of a network and the transition between using different networks is handled seamlessly from the view of a user of wireless modem 305. Alternatively, modem control 330 can prompt a user or connected device for confirmation or selection of a wireless network.

Modem control 330 is connected to a modem interface 335. Modem interface 335 provides a connection between wireless modem 305 and a terminal, such as terminal 205 in FIG. 2.

Wireless modem 305 can be implemented as a one-chip solution, or a collection of connected components. Wireless modem 305 can be implemented using various forms. In one implementation, wireless modem 305 is embedded in a terminal and so is an integral part of the terminal. In another implementation, wireless modem 305 is part of a removable card to be inserted within a terminal, such as a PCMCIA card or a card compatible with a memory card interface (e.g., a SmartMedia™ card by Toshiba, Inc.). In another implementation, wireless modem 305 is a separate device that can be connected to a terminal such as by a wired or wireless link (e.g., a short-range wireless link or interface, such as Bluetooth).

In alternative implementations, a wireless modem 305 includes more than two sets of antennas and air interfaces. In addition, in some implementations, two or more air interfaces for networks operating at the same or similar frequency ranges can share an antenna.

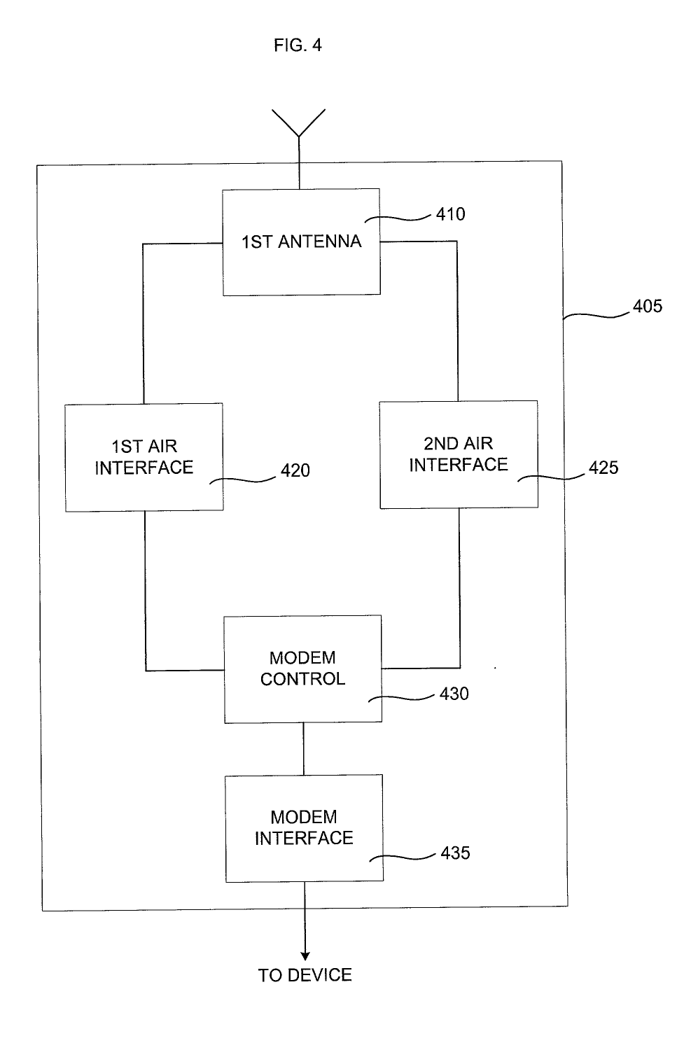

FIG. 4 is a block diagram of another implementation of a wireless modem 405. In contrast to wireless modem 305 shown in FIG. 3, wireless modem 405 has one antenna 410, rather than two. Wireless modem 405 operates within a single frequency range, such as 1.8-2 GHz. Similar to wireless modem 305 in FIG. 3, wireless modem 405 has a first air interface 420, a second air interface 425, a modem control 430, and a modem interface 435. Air interfaces 420, 425, modem control 430, and modem interface 435 operate similarly in wireless modem 405 as described above for wireless modem 305 in FIG. 3. However, air interfaces 420, 425 share antenna 410. Data is transmitted and received for both air interfaces 420, 425 through antenna 410.

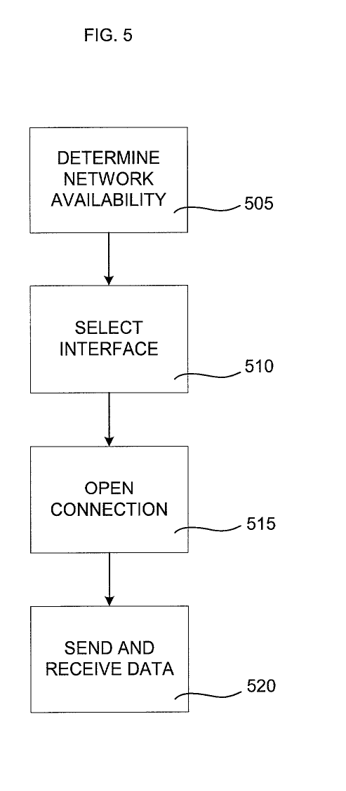

FIG. 5 is a flow chart of opening a connection between a wireless modem and a server through a wireless network, such as wireless modem 305 in FIG. 3 and the network system shown in FIG. 2. The wireless modem determines the availability and quality of a connection to each of the compatible networks, block 505. The wireless modem monitors signals received from each compatible network. The wireless modem stores access information indicating which networks currently provide an acceptable signal and the available data rates. The access information can also include other information about the current state of connecting to the networks, such as cost and energy consumption. The wireless modem can monitor the networks continually while the wireless modem has power, or alternatively can check network availability upon demand, such as when attempting to open a connection. For example, referring to FIG. 2, the wireless modem in terminal 205 can determine that both, either, or neither of first network 230 and second network 235 are available and the currently available data rates.

Based upon the stored access information and selection criteria, the wireless modem selects which air interface and antenna combination to use to communicate with an available wireless network, block 510. The selection criteria can be pre-defined, such as by the manufacturer or service provider, or updated by the user, such as when opening a connection through the wireless modem. Various selection criteria can be used. In one implementation, the selection criteria select the network that provides the higher data rate. For example, referring again to FIG. 2, where first network 230 is the primary network and second network 235 is a secondary network, the wireless modem selects the air interface corresponding to first network 230 if first network 230 has a higher available data rate. If second network 235 currently provides a higher data rate, the wireless modem selects the air interface corresponding to second network 235. If the available data rates are the same, or within a defined range, the wireless modem selects first network 230, the primary network. In another implementation, the selection criteria select the primary network if available, though the secondary network may currently provide a higher data rate. If the primary network is not available, the wireless modem selects the secondary network. In alternative implementations, the wireless modem can use different selection criteria to select the air interface and antenna combination, such as lower current price or lower energy consumption, or some combination of criteria. If both networks are not available, the wireless modem informs the user that a connection is not available.

Using the selected air interfaces and antenna, the wireless modem opens a connection to the server through the wireless network corresponding to the selected air interface, block 515. Referring again to FIG. 2, when the wireless modem of terminal 205 has selected first network 230, terminal 205 opens a connection to server 210 through first base station 220. Wireless modem sends and receives data to the server across the open connection, block 520. As described above, in one implementation, the wireless modem breaks data to be sent into packets and reassembles received packets while using the first packet switched network, but does not packetize or reassemble data packets while using the second circuit switched network.

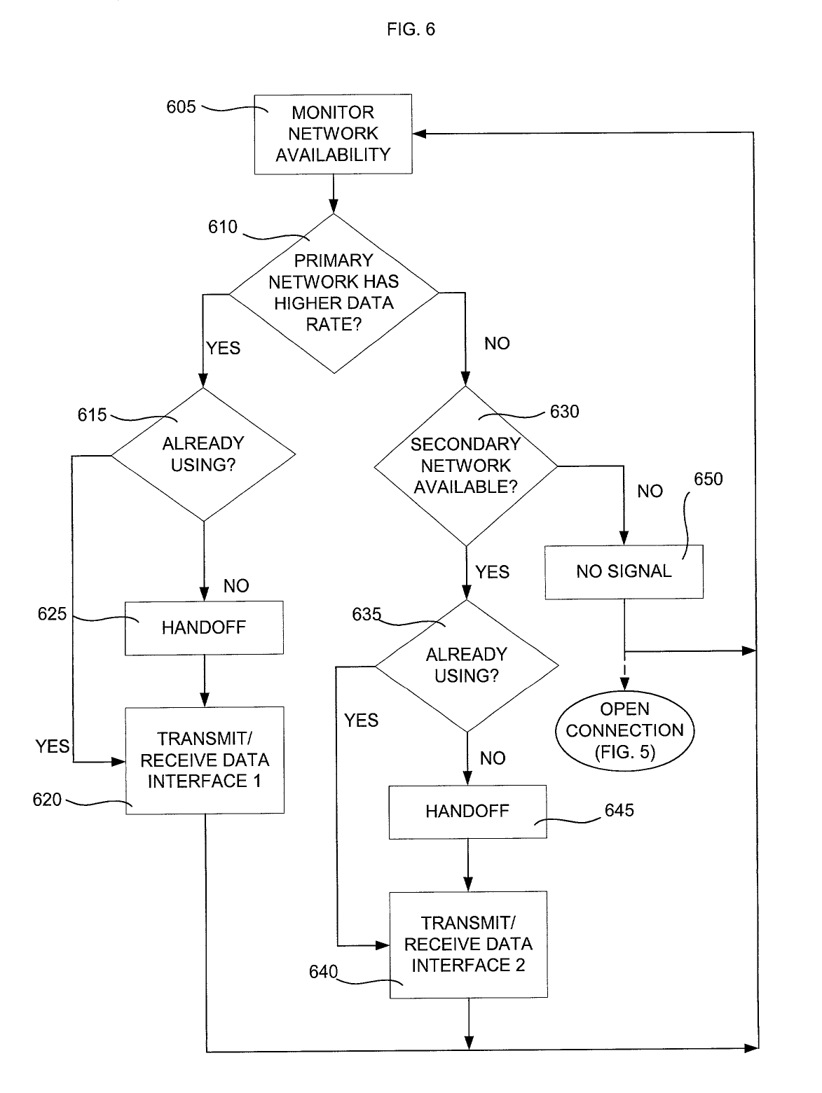

FIG. 6 is a flow chart of maintaining a connection between a wireless modem and a server through one or more wireless networks, such as wireless modem 305 in FIG. 3 and the network system shown in FIG. 2. In FIG. 6, the selection criteria select the network currently providing the higher data rate. In alternative implementations, the wireless modem can use different selection criteria and the selection criteria can be changed by the user. As the wireless modem sends and receives data to and from the server across an open connection, the wireless modem gathers access information about the compatible networks, such as by monitoring the availability and available data rates of the compatible networks, block 605. As the physical environment of the wireless modem changes, such as when the user changes physical location, the compatible wireless networks may become available or unavailable, or the available data rates may change. For example, referring to FIG. 1, as a user moves from point A to point B, the user leaves coverage area 105 and so the first network is no longer available. In another example, the available data rate for the first network is higher than the available data rate for the second network at point A, but the available data for the second network is higher than the available data rate for the first network at point C. In this case, where the selection criteria select the network currently providing the higher data rate, the wireless modem uses the first network at point A and uses the second network at point C. The wireless modem monitors networks and gathers access information for maintaining a connection similarly to how the wireless modem monitors networks and gathers access information for opening a connection. The wireless modem monitors the networks at regular intervals and stores the access information to indicate the current state of connectivity, such as indicating which networks are currently available and the available data rates.

According to the selection criteria, the wireless modem determines whether the primary network is available or not and whether the primary network provides a higher data rate, block 610. If the primary network is available and provides substantially the same or a higher data rate than the secondary network, the wireless modem determines whether the wireless modem is already using the primary network, block 615. If the wireless modem is already using the primary network, the wireless modem continues to send and receive data through the air interface corresponding to the primary network, block 620. If the wireless modem is not already using the primary network, the wireless modem initiates a handoff from the current network to the primary network, block 625, and begins to send and receive data through the air interface corresponding to the primary network, block 620. While the connection to the server is open, the wireless modem continues to monitor the availability of compatible networks, block 605.

Returning to block 610, if the wireless modem determines that the primary network is not available or that the secondary network provides a higher data rate, the wireless modem determines whether the secondary network is available, block 630. If the secondary network is available, the wireless modem determines whether the wireless modem is already using the secondary network, block 635. If the wireless modem is already using the secondary network, the wireless modem continues to send and receive data through the air interface corresponding to the secondary network, block 640. If the wireless modem is not already using the secondary network, the wireless modem initiates a handoff from the current network to the secondary network, block 645, and begins to send and receive data through the air interface corresponding to the secondary network, block 640. While the connection to the server is open, the wireless modem continues to monitor the availability of compatible networks, block 605.

Returning to block 630, if the wireless modem determines the secondary network is not available, the wireless modem informs the user or connected device that the signal has been lost and the connection is closed, block 650. To open a new connection, the wireless modem determines the availability of the compatible networks as described above, block 505 in FIG. 5.

FIGS. 5 and 6 illustrate opening and maintaining connections with two compatible networks. However, in alternative implementations, a wireless modem may have more than two compatible networks. In addition, multiple secondary networks may be prioritized as well.

Various illustrative implementations of the present invention have been described. The above description focuses on a wireless modem interacting with two wireless data networks, however additional variations are possible. For example, a wireless modem may be compatible with three wireless networks. As described above, one or more of the wireless networks can be a packet switched network. The present invention can be implemented in electronic circuitry, firmware, or in combinations of them. For example, modem control 330 shown in FIG. 3 can be implemented in various ways, such as with an FPGA, a hardwired design, a microprocessor architecture, or a combination. However, one of ordinary skill in the art will see that additional implementations are also possible and within the scope of the present invention. Accordingly, the present invention is not limited to only those implementations described above.

What is claimed is:

1. A modem, comprising:
at least one antenna;
a plurality of air interface components, where each air interface component is connected to an antenna and each air interface component corresponds to a respective wireless network, where at least one wireless network is a packet switched network;
a modem control component, where the modem control is connected to each of the air interface components; and
a modem interface, where the modem interface is connected to the modem control component.

2. The modem of claim 1, where the second wireless network is a circuit switched network.

3. The modem of claim 2, where the second wireless network is a CDMA network.

4. The modem of claim 1, where the first wireless network uses IP packets.

5. The modem of claim 1, where a first air interface component corresponds to a packet switched network and a second air interface component corresponds to a circuit switched network, and where the first air interface component packetizes data to be sent to the first wireless network.

6. The modem of claim 5, where the second air interface component does not packetize data to be sent to the second wireless network.

7. The modem of claim 1, where the modem control component determines the availability of the wireless networks corresponding to the air interface components.

8. The modem of claim 1, where the modem control component selects one air interface component to use to communicate with an available wireless network.

9. The modem of claim 8, where the modem control component selects one air interface component to use based on which of the wireless networks currently provides a higher data rate.

10. The modem of claim 8, where the modem control component selects one air interface component to use based on which of the wireless networks currently provides a lower cost.

11. The modem of claim 8, where the modem control component selects one air interface component to use based on which of the wireless networks currently provides a lower energy consumption rate.

12. The modem of claim 8, where the modem control component selects the air interface component corresponding to the wireless network that is a primary network if available.

13. The modem of claim 1, where the modem interface is compatible with a PCMCIA interface.

14. The modem of claim 1, where the modem interface is compatible with a memory card interface.

15. The modem of claim 1, where the modem interface is compatible with a USB interface.

16. The modem of claim 1, where the modem interface is compatible with an IEEE-1394 interface.

17. The modem of claim 1, where the modem interface is compatible with a short-range wireless interface.

18. The modem of claim 1, where the modem comprises two antennas.

19. The modem of claim 18, where each air interface component is connected to a respective antenna.

20. A method of sending and receiving data, comprising:
monitoring availability of a first wireless network and a second wireless network, where the first wireless network is a packet switched network;
if the first wireless network is available, sending and receiving data through a first air interface using the first wireless network; and
if the first wireless network is not available, sending and receiving data through a second air interface using the second wireless network.

21. The method of claim 20, further comprising packetizing data to be sent through the first air interface.

22. The method of claim 20, where monitoring availability of the first wireless network and the second wireless network comprises determining which wireless network currently provides the higher data rate.

23. The method of claim 20, where the first wireless network is available if the first wireless network currently provides a higher data rate than the second wireless network.

24. A system for sending and receiving data, comprising:
means for monitoring availability of a first wireless network and a second wireless network, where the first wireless network is a packet switched network;
means for sending and receiving data through a first air interface using the first wireless network if the first wireless network is available; and
means for sending and receiving data through a second air interface using the second wireless network if the first wireless network is not available.
